(19) United States
(12) Patent Application Publication
(10) Pub. No.: US 2006/0213005 A1
(43) Pub. Date: Sep. 28, 2006

(54) System for supplying useful-to-human-body substance into human body utilizing sauna space

(75) Inventor: Kiyotugu Tanaka, Oita (JP)

Correspondence Address: SNIDER & ASSOCIATES, P. O. BOX 27613, WASHINGTON, DC, 20038-7613, US

(73) Assignee: TANAKA KOSANKAKENKYUSHO CO., LTD., OITA-CITY (JP)

(21) Appl. No.: 10/529,464

(22) PCT Filed: Oct. 3, 2003
(86) PCT No.: PCT/JP03/12762

§ 371 Date: Apr. 10, 2006

(30) Foreign Application Priority Data
Oct. 4, 2002 (JP) 2002-292725

(51) Int. Cl. A61H 33/06

(52) U.S. Cl. 4/531

(57) ABSTRACT

A system for supplying useful-to-human-body substances into a human body utilizing a sauna space, comprising a sauna room being used by one or a plurality of users, a section for supporting at least the waist and the back of a user in the sauna room, a high-temperature steam or the like supply section for supplying high-temperature micro-particles or steam of about 60° C. or above, and a low-temperature mist supply section for atomizing a low-temperature liquid of about 30° C. or below containing substances having actions useful for the human body, e.g. a nourishing/restoring action, an immunity activating action, an organism conditioning action, or the like through ultrasonic vibration and discharging the atomized liquid toward the face of the user.

### TECHNICAL FIELD

The present invention relates to a system for supplying useful-to-human-body substances into a human body utilizing a sauna space which allows micro particles containing useful-to-human-body substances to be effectively absorbed through lungs into a user's body while the user is in a sauna (steam bath), thereby keeping the user in a good health state.

### BACKGROUND ART

Conventionally, there has been known a single room type of a sauna unit (steam bath unit) which can be installed in a private house or the like, which is useful to warm up the whole body of a user and stimulate blood circulation and perspiration, thereby keeping the user in a good health state.

For instance, Japanese Patent Laid-Open No. 5-15570 suggests a shower system in which hot water supplied from a boiler is turned into high-temperature micro particles and the high-temperature micro particles are discharged to the body surface of a user except face while the user seats on a chair, thereby warming up the body surface of the user. In addition, the shower system of the invention in the publication has been proposed to achieve an object of preventing the user from feeling uncomfortable in breathing while the user is in a general steam sauna facility (a user usually has hard time in breathing due to the presence of high-temperature micro particles around his/her face) by not making an atmosphere full of high-temperature micro particles around the face of the user.

In addition, Japanese Patent Laid-Open No. 11-104208 suggests a sauna facility having a body accommodating structure on a bed. The body accommodating structure is used for accommodating the body below the neck of the user but exposing the head of the user over the neck to the outside, while high-humidity gas (steam) or atomized liquid (mist) is supplied along with hot air into the body accommodating structure, thereby forming a sauna atmosphere therein. The sauna facility of the aforementioned invention in the publication has been proposed to achieve an object of preventing the user from feeling uncomfortable in breathing while the user is in a general steam sauna facility (a user usually has hard time in breathing due to the presence of high-temperature mist or steam around the face) by constructing to get the user's face exposed out of the body accommodating structure.

However, the aforementioned shower system or sauna facility built in private houses satisfies only a object of supplying high-temperature mist or steam to warm up the body (particularly, body except face) of a user and stimulating blood circulation and perspiration of the body, but fails to accomplish other purposes of, for example, helping a user utilizing the sauna facility to effectively absorb substances having an immunity activating action, a nourishing/restoring action or an organism conditioning action into his/her body. When a user is in a sauna facility, the user's body is kept under restraint at least for a predetermined time period in one place. Therefore, there has been a strong demand that the user would like to obtain added value of other activities during the time period when the user's body is kept under restraint in the steam bath, but the related art has failed to achieve such a strong demand.

### DISCLOSURE OF THE INVENTION

It is an object of the present invention to solve the aforementioned problems in the related art and provide a system for supplying useful-to-human-body substances into a human body utilizing a sauna (steam bath) space, which enables useful-to-human-body substances having actions useful for the human body, e.g., actions of enhancing immunity against illnesses or promoting natural recovery in a body (an immunity activating action), an organism conditioning action, or a nourishing/restoring action to be effectively adsorbed through active lung respiration and blood circulation into the whole body of a user while the user is using a sauna (steam bath).

In order to solve the above-mentioned problems of the related art, the present invention provides a system for supplying useful-to-human-body substances into a human body utilizing a sauna (steam bath) space. The system includes a sauna room for forming the sauna space almost completely blocked from outside except a ventilation hole performing ventilation with outside while one or a plurality of users are using it as a steam bath, a high-temperature steam or the like supply section for supplying high-temperature micro particles or vapors (water vapors) of about 60° C. or above to the inside of the sauna room and raising the temperature of the sauna room to warm up the body of the user in the sauna room and further stimulate blood circulation and metabolism, and a low-temperature mist supplying section for discharging low-temperature mist of about 30° C. or below made by atomizing a liquid containing useful-to-human-body substances toward the face (mouth or nose) of a user from a position over or near to the face or head of the user for a predetermined period of time or more (at least about 10 minutes) simultaneously with the supply of the high-temperature micro particles or vapors from the high-temperature steam or the like supply section. While the high-temperature micro particles or vapors are discharged from the high-temperature steam or the like supply section to warm up the body of the user and activate blood circulation and metabolism, the low-temperature mist supplied from the low-temperature mist supplying section is sucked through the mouth or nose of the user into the lungs, thereby making the useful-to-human-body substances contained in the low-temperature mist more effectively spread and absorbed through lung respiration and blood circulation of the user into the whole body of the user.

Further, in the present invention, the high-temperature stream or the like supplying section includes a water tank for storing water, and a heater for heating the water stored in the water tank. The water is heated by the heater to form high-temperature micro particles or vapors of about 60° C. or above. The high-temperature micro particles or vapors are supplied for at least about 10 minutes to the sauna space to raise the internal temperature of the sauna room to thereby warm up the body of a user and activate blood circulation and metabolism of the user.

Further, in the present invention, the low-temperature mist supplying section includes a liquid tank for storing a low-temperature liquid of about 30° C. or below, an ultrasonic vibrator for atomizing the liquid stored in the liquid tank, and a discharging nozzle provided at a position near to or above the face or head of the user for discharging the low-temperature mist of 30° C. or below atomized by ultrasonic vibrator toward the mouth or nose of the user. Here, the low-temperature liquid contains substances having actions useful for the human body, e.g., an immunity activating action or a natural recovery force enhancing action against illnesses, an organism conditioning action, or a nourishing/restoring action. The low-temperature liquid can also be used as beverages having effects of curing the predetermined illnesses or promoting general physical health. Also, the low temperature liquid can be sucked into the mouth or nose of the user while being turned into mist, and thereby the useful-to-human-body substances can be absorbed into the body of the user through lung respiration and blood circulation to effectively achieve the illness curing effect and the physical health promoting effect.

Moreover, in the present invention, it is preferable that the useful-to-human-body substances contained in the liquid are obtained from at least one raw material of medicinal herbs such as Korean ginseng, medicinal mushroom and curcuma, rice bran, embryo buds, loquat leaves, loquat seeds, edible mushroom, fucoidan, chitosan and chitin. In addition, chitosan is known to have a curing effect of diseases such as liver cancer, kidney cancer, stomach cancer, uterine cancer, and thyroid cancer and a resistance action against oxidation (an antioxidant action).

Further, in the present invention, it is preferable that the liquid should include substances being obtained in the process of fermentation of at least one of rice bran, embryo buds, loquat leaves, loquat seeds, Korean ginseng, edible mushrooms and medicinal mushrooms using fermentative bacteria such as lactic acid bacteria or yeast fungi and having a resistance action against oxidation.

Further, in the present invention, it is preferable that the supply of the high-temperature steam or the like (high-temperature micro particles or vapors of about 60° C. or above) from the high-temperature steam or the like supply section to the sauna room and the supply of the low-temperature mist from the low-temperature mist supplying section toward the mouth or nose of the user are performed simultaneously and continuously for at least 10 minutes.

Further, in the present invention, it is preferable that the sauna room is formed substantially in the shape of a capsule, as seen from above, an opening is formed in an upper portion of the sauna room for allowing entrance or exit of an user, the opening is provided with transparent doors formed in the shape of lids which are mounted to open or close the opening, and the opening is positioned to face the user when the body of the user is supported by the supporting section.

Further, in the present invention, it is preferable that the opening of the sauna room is provided with a hinged portion extending along a longitudinal centerline that divides the opening into symmetrical right and left halves as seen from a user supported by the supporting section, and the transparent doors are composed of a first transparent door mounted to the hinged portion for opening or closing a right portion of the opening with respect to the centerline as seen from the user side, and a second transparent door mounted to the hinged portion for opening or closing a left portion of the opening with respect to the centerline as seen from the user side.

In addition, in the present invention, it is preferable that a bottom of the sauna room is provided with a tank for temporarily collecting and storing moisture resulting from dropping of the high-temperature micro particles or water vapors of 60° C. or above from the high-temperature steam or the like supplying section before the moisture is drained out of the sauna room.

### BRIEF DESCRIPTION OF THE DRAWINGS

FIG. 1 is a perspective view illustrating an appearance of a system for supplying useful-to-human-body substances into a human body using a sauna space according to an embodiment of the present invention.

FIG. 2 is a plan view of the embodiment as seen from above.

FIG. 3 is a front view of the embodiment as seen from the front.

FIG. 4 is a projection view of the embodiment as seen from a side for explaining its internal structure.

FIG. 5 is a schematic view of the embodiment for explaining the structure of a high-temperature steam generating section (heating tank).

FIG. 6 is a schematic view of the embodiment for explaining the structure of a low-temperature mist generating section.

### BEST MODE FOR CARRYING OUT THE INVENTION

In order to explain the present invention in more detail, a preferred embodiment of the present invention will now be described with reference to the accompanying drawings.

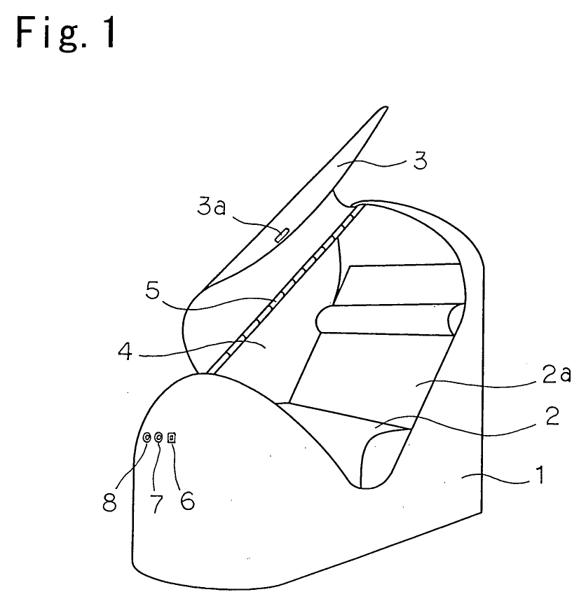

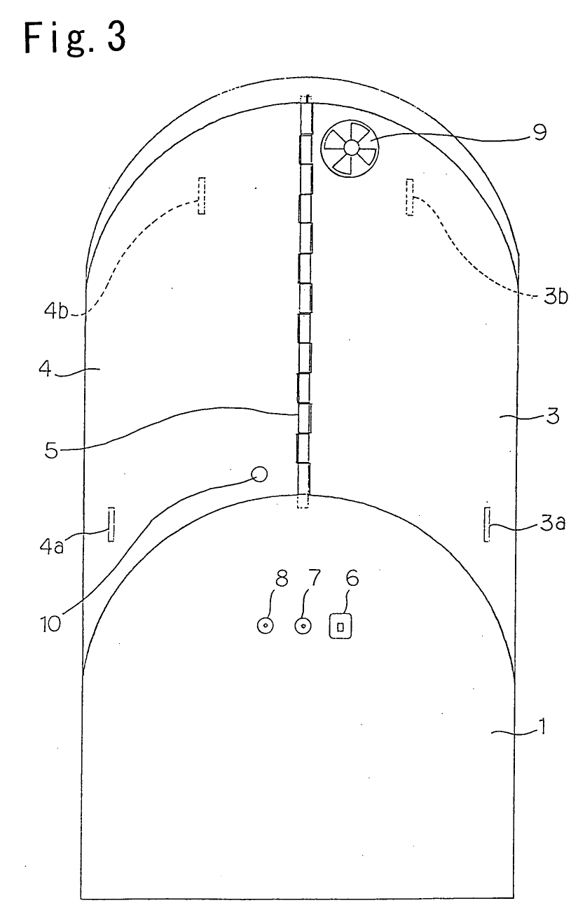

In FIGS. 1 through 4, reference numeral 1 indicates a plastic container body used for a sauna room, and reference numeral 2 indicates a chair-shaped human body supporting section (including a backrest 2a) provided in the container body 1. A relatively large opening is formed at a position that faces the human body supporting section 2, that is, a position close to the eye of a user while the body of the user is supported by the human body supporting section 2 in the container body 1.

In FIGS. 1 through 4, reference numeral 5 indicates a hinged portion arranged along a centerline (a longitudinal centerline seen by the user) that divides the opening into left and right halves. A stainless steel rod passes through the hinged portion 5. Reference numeral 3 indicates a transparent door made of acrylic resin for opening or closing the left half of the opening when the opening is seen by a user, and reference numeral 4 indicates the other transparent door made of acrylic resin for opening or closing the right half of the opening when the opening is seen by a user. Reference numerals 3a and 4a indicate external grips that the user holds to open or close the transparent doors 3 and 4 from the outside, and reference numerals 3b and 4b are internal grips that the user holds to open or close the transparent doors 3 and 4 from the inside.

Further, in FIGS. 1 through 4, reference numeral 6 is an operating switch to be pressed when a user starts the operation of the system according to the embodiment, and reference numeral 7 is a timer setting button to be used when a user sets the time (the timer is set to 30 minutes as a default time) to continue operating the system according to the embodiment. Reference numeral 8 is a temperature controlling button to be used when a user sets a desired temperature (usually about 50° C. to 60° C.) of the sauna room according to the embodiment. In addition, in order to set the temperature in the sauna space of the container body 1 to 50° C. to 60° C., it is necessary to supply high-temperature steam or mist of about 60° C. to 100° C. into the sauna room.

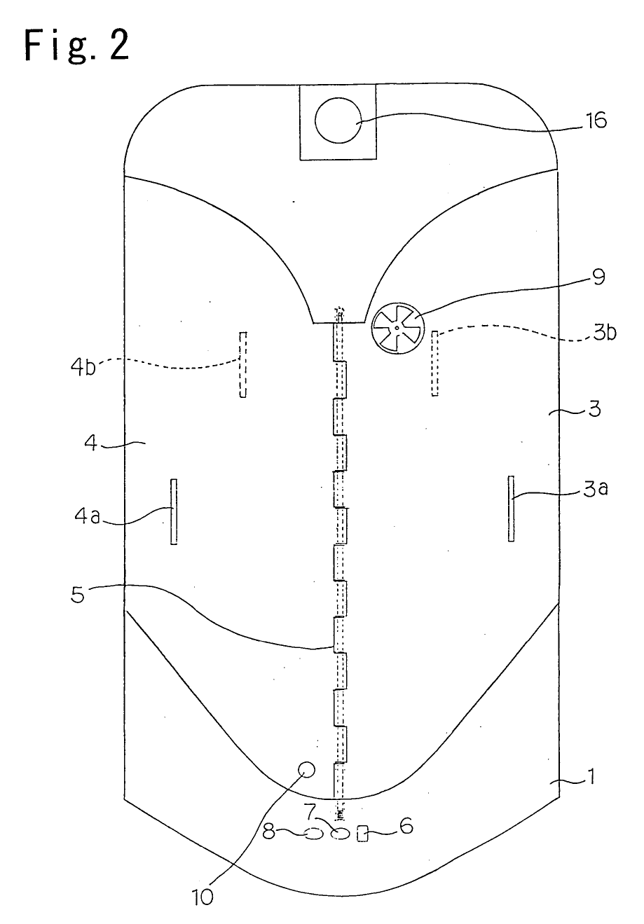

Further, in FIGS. 2 through 4, reference numeral 9 is a manual type of a ventilation hole formed at an upper position with respect to FIG. 2 of the transparent door 3 which can be opened or closed by a user as he/she rotates it manually, and reference numeral 10 is an air suction hole (ventilation hole) formed at a lower position with respect to FIG. 2 of the transparent door 4.

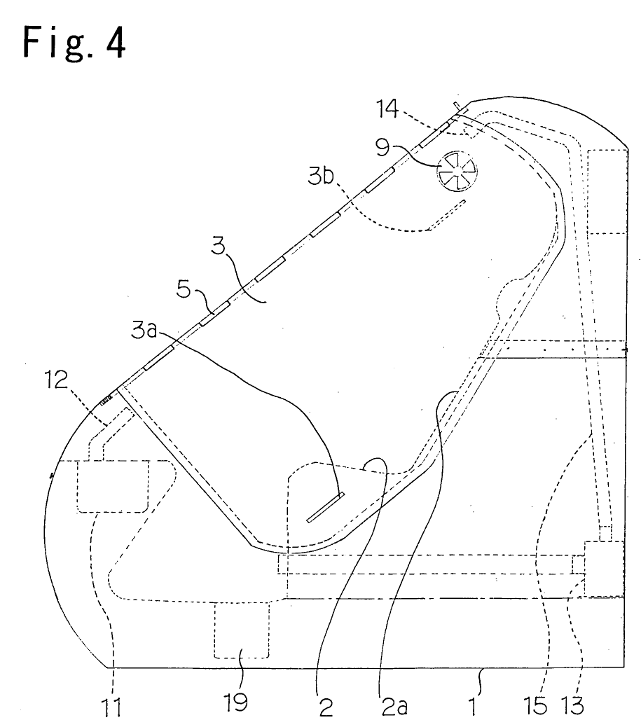

Further, in FIG. 4, reference numeral 11 indicates a heating tank (a steam generating section) provided at the bottom of the container body 1. The heating tank 11 includes a water tank for storing tap water and a submerged heater (not shown) for heating up the water contained in the water tank. Water vapors of about 60° C. to 100° C. are generated from the heating tank 11 when the water in the water tank is heated up by the submerged heater.

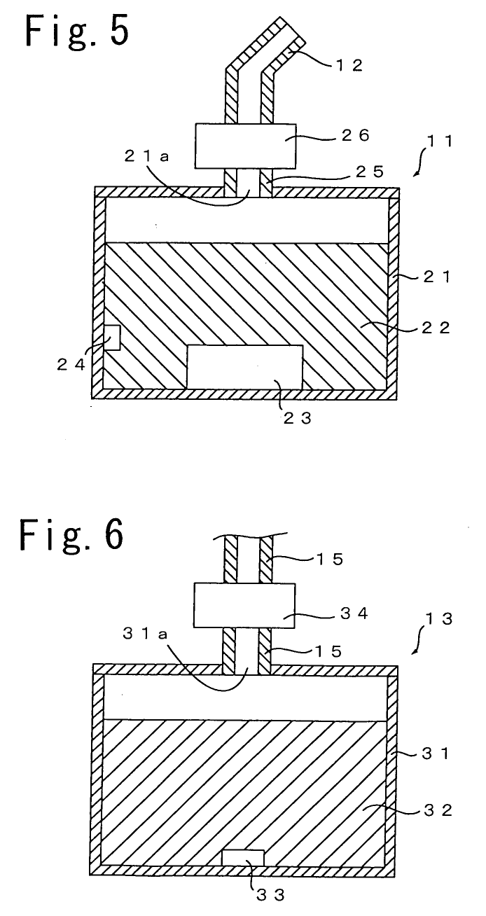

Furthermore, reference numeral 12 is a steam discharging nozzle for discharging vapors generated from the heating tank 11 toward the upper ‘sauna space’ from a position in the vicinity of the foot of a user while the user seats on the human body supporting section 2. The vapors generated from the heating tank 13 move to the steam discharging nozzle 14 to be discharged by a fan (refer to reference numeral 26 in FIG. 5 which will be described below).

In the present description, the sauna space is a space surrounding the body of the user supported by the body supporting section 2 in the container body 1 and designed to be able to be full of the vapors.

In other words, the high-temperature steam or the like supply section of the invention is constructed with the heating tank 11, the steam discharging nozzle 12, and the fan (refer to 26 in FIG. 5 which will be described below).

Further, in FIG. 4, reference numeral 13 is a low-temperature mist generating section provided at the bottom of the container body 1. The low-temperature mist generating section 13 is constructed with a liquid tank for storing a predetermined amount of liquid in which substances having actions useful for the human body, e.g. a nourishing/restoring action, an immunity activating action, and an organism conditioning action and the like are dissolved, and an ultrasonic vibrator (not shown) for atomizing the liquid stored in the liquid tank. In other words, the low-temperature mist generating section 13 turns the liquid into micro particles through vibration of the ultrasonic vibrator.

Further, in FIG. 2, reference numeral 16 is a liquid supplying hole for supplying the liquid to the liquid tank.

The liquid stored in the liquid tank contains useful microorganisms (those having an effect of resistance to oxidation) beneficial to human health, for instance, fermentative bacteria (fermenting microorganisms) such as lactic acid bacteria, yeast fungi, Aspergillus niger, penicillium and acetic acid bacteria; Aspergillus; and photosynthetic microorganisms.

Moreover, the liquid contains substances (vitamin, physiologically active substances or the like) resulting from the fermentation process of rice bran, embryo buds, loquat leaves, loquat seeds, Korean ginseng, edible mushrooms and medicinal mushrooms (such as agaricus known for an immunity activating function or an anticancer function).

The liquid in the present embodiment is stored and kept in the liquid tank at room temperature (for instance, about 5° C. to 30° C.). In the present embodiment, the liquid may be healthful beverage (nutritious drinks) or antioxidant drinks that patients or old people drink to stimulate health recovery against illnesses such as cancers (particularly, pulmonary cancer, laryngeal cancer, pleural cancer, liver cancer and the like), skin irritations (atopic dermatitis), asthma, empyema and the like or to deray aging.

In other words, the liquid contains substances (vitamin, physiologically active substances, antioxidant substances and the like) obtained by fermenting and aging raw materials such as rice bran, embryo buds, loquat leaves, loquat seeds, Korean ginseng, edible mushrooms and medicinal mushrooms with the above-mentioned fermentative bacteria for a prolonged period of time of about six or more months, and by extracting active ingredients and biosynthetic ingredients possessed by the raw materials. The liquid is, for instance, a liquid as a healthful beverage beneficial to users who have health problems such as cancers, asthma, empyema, skin irritations or other physical weaknesses. In addition, the physiologically active substances means various substances helpful to promote physical functions, secretion of hormones into tissues (cells) and metabolism of tissues (cells) and to boost the immune system's ability against illnesses.

The liquid presented in the present embodiment also contains a variety of minerals such as sodium, calcium, potassium, and magnesium. Further, the liquid also contains γ-oryzanol extractable from brown rice or the like, and amygdalin (vitamin 17) extractable from loquat leaves, loquat seeds or the like. Furthermore, the liquid contains other active ingredients originated from beneficial microorganisms such as antioxidant enzymes such as catalase, glutathione, and peroxidase, and decomposing enzymes such as ubiquinone, amylase, pepsin, and lipase.

Further, in FIG. 4, reference numeral 14 indicates a mist discharging nozzle for discharging the micro particles of liquid generated by the low-temperature mist generating section 13 with a fan (refer to reference numeral 34 in FIG. 6 which will be described below) toward the face of a user from an upper or near position of the user while the user is supported by the human body supporting section 2. In the present embodiment, the mist discharging nozzle 14 is provided on the ceiling of the container body 1 or on an upper portion of a lateral wall thereof (a position upper and near to the face or head of the user).

Further, in FIG. 4, reference numeral 15 indicates a pipe for delivering the low-temperature mist generated by the low-temperature mist generating section 13 to the mist discharging nozzle 14.

Therefore, the low-temperature mist supplying section of the present invention is constructed with the low-temperature mist generating section 13, the mist discharging nozzle 14, the pipe 15 and the fan (refer to reference numeral 34 in FIG. 6 which will be described below) Further, in FIG. 4, reference numeral 19 indicates a drain tank provided at the bottom of the container body 1. The drain tank 19 is provided for temporarily collecting and storing water drops that turn from the vapors discharged by the steam discharging nozzle 12 to the sauna space and then fall on the floor of the container body 1. The water collected and stored in the drain tank 19 can be drained outside by the manipulation of a user.

Further, FIG. 5 is a schematic view illustrating an example of the structure of the heating tank 11 (steam generating section) shown in FIG. 4. In FIG. 5, reference numeral 21 is a water tank (a place where a user stores tap water supplied by a water supplying tap which is not shown) for storing water 22 like tap water, and reference numeral 23 is a submerged heater provided at the bottom of the water tank 21. Reference numeral 24 is a water level sensor provided at the lower portion of the lateral wall of the water tank 21, and reference numeral 25 is a pipe inserted through the opening 21a in an upper lid of the water tank 21. Reference numeral 26 is the fan interposed between the pipe 25 and the steam discharging nozzle 12 (refer to FIG. 4).

In the heating tank 11 shown in FIG. 5, when a user heats up the water 22 stored in the water tank 21 with the submerged heater 23 to generate vapors, the generated vapors of high temperature is discharged by the fan 26 through the pipe 25 and the steam discharging nozzle 12 from the lower portion of the sauna space (from the position in vicinity of the foot of the user in the container body 1) to the upper portion of the sauna space.

In addition, in the present embodiment, the water of, for example, about 1.5 to 2.0 liters can be filled and stored in the water tank 21 at one time. The user can use the present embodiment with the water of about 1.5 to 2.0 liters about 2 to 5 times (about 30 minutes for each use). For instance, a user may repeat 30 minutes' steam bath with 10 minutes' break. In the present embodiment, an operational process may also be repeated 3 to 5 times in units of the 10 minutes' use and 5 minutes' break.

Further, FIG. 6 is a schematic view illustrating an example of the structure of the low-temperature mist generating section 13 (refer to FIG. 4). In FIG. 6, reference numeral 31 is a liquid tank for storing the liquid 32 containing useful-to-human-body substances, and reference numeral 33 is an ultrasonic vibrator installed at the bottom of the water tank 31. Reference numeral 15 is a pipe inserted through an opening 31a of an upper lid of the liquid tank 31, that is, a pipe for delivering the low-temperature mist to the low-temperature mist discharging nozzle 14 (refer to FIG. 14). Reference numeral 34 is a fan interposed in a middle portion of the pipe 15.

In the low-temperature mist generating section 13 shown in FIG. 6, the liquid 32 stored in the liquid tank 31 is atomized (micro particles of the liquid are generated) from the surface of the liquid 32 by the resonance with the vibration of the ultrasonic vibrator 33. Then, the micro particles of the liquid are scattered over the surface of the liquid like a mist. The micro particles of the liquid are blown up by the fan 34 and are discharged from the mist discharging nozzle 14 (refer to FIG. 4) through the pipe 15 toward the face of a user.

In addition, the ultrasonic vibrator 33 has, for example, a structure in which electrodes are respectively provided on both surfaces of a small disk-shaped piezoelectric ceramic plate. A predetermined frequency of high-frequency voltage is applied to the electrodes of the ultrasonic vibrator 33 to thereby generate a predetermined frequency of ultrasonic waves (high-frequency energy).

Further, in the present embodiment, for instance, about 4 liters of the liquid 32 can be stored in the liquid tank 31. The user can utilize the present embodiment several times with about 4 liters of the liquid. In addition, the liquid used in the present embodiment contains antioxidant substances resulting from the action of the microorganisms having a fermentation function (the microorganisms having an antioxidant function). Therefore, there will be no change or decomposition of the liquid even when it is left for several days.

Hereinafter, a general method of utilizing the present embodiment will be described briefly. First, a user manipulates the operating switch 6 to initiate the operation of the present embodiment. Then, the submerged heater 23 of the heating tank (the steam generating section) 11 operates to discharge high-temperature steam to the sauna space. When about 10 minutes has elapsed, the interior of the sauna space turns into the warm sauna atmosphere of, for example, 40° C. to 60° C. filled with high-temperature steam.

At this step, the user takes off clothes, gets in the sauna space through the transparent door 3 or 4 and sits on the supporting section 2. At this time, the user starts operation of the low-temperature mist generating section 13 of the present embodiment by handling the operating switch 6 (or, the low-temperature mist may be automatically generated and discharged by a microcomputer and a timer, about 10 minutes after the high-temperature steam starts to be generated).

After this step, the user seating in the sauna space starts to feel warm, and the blood circulation, the perspiration and the metabolism of the user will be stimulated and activated. At the same time, the low-temperature mist (the micro particles of the liquid containing useful-to-human-body substances) generated by the low-temperature mist generating section 13 is supplied toward the face of the user, and the low-temperature mist (the micro particles) will be absorbed into the lungs of the user when the user is breathing in the low-temperature mist. The useful-to-human-body substances of the low-temperature mist absorbed into the lungs are absorbed into the blood vessels via the mucous membrane of lungs of the user, and further into the whole body of the user by blood circulation.

As described above, the blood circulation and metabolism are stimulated in the body of the user by the high-temperature steam, and the useful-to-human-body ingredients of the low-temperature mist (micro particles) absorbed through lung respiration are extremely rapidly and effectively spread and absorbed into the whole body of the user by the active circulation of blood of the user.

Then, after the above-mentioned high-temperature steam and low-temperature mist continue to be supplied for about 15 to 20 minutes, a timer (not shown) built in the present embodiment confirms the elapse of the preset time of 25 to 30 minutes and a microcomputer (not shown) built in the present embodiment receives a signal from the timer to stop the operation of discharging the high-temperature steam and low-temperature mist.

The inventor has reported the following experimental results after the system of the present embodiment was manufactured by way of trial, and several monitoring members used the system of the present embodiment and tested the effects of the system. In addition, in the experiments, a nutrition supplementary drink (a healthful beverage) named ‘Balance-α’ (brand name) manufactured and sold by Japanese Antioxidant Beverage Co. (82-9, Oaza Kawashiro Aza Sakuragaoka, Haguro-machi, Higashitagawa-gun, Yamagata-ken, Japan) was used as the liquid to be stored in the liquid tank 31 of the low-temperature mist generating section 13.

For instance, the ‘Balance-α’ is a healthful beverage obtained by fermenting and aging raw materials such as rice bran, embryo buds, loquat leaves, loquat seeds, Korean ginseng, edible mushrooms and medicinal mushrooms with the fermentative bacteria, such as yeast fungi or lactic acid bacteria, for a prolonged period of time of about six or more months, then by extracting the substances (substances having an antioxidant function including vitamin, physiologically active substances and the like) by filtering and pasteurization treatment of substances obtained through the fermentation and aging process (at this time, microorganisms such as fermentative bacteria are removed), and finally by diluting the extracted substances with mineral water.

Experiment 1: Woman patient A of sixties diagnosed with a laryngeal cancer was made to keep on using the present embodiment for 2 hours (by repeating the 30 minutes' use with a 10 minutes' break) almost everyday, for about 4 months from January through April in 2001. When an X-ray test was performed in a hospital after the 4 months' use of the present embodiment, the laryngeal cancer is almost no longer detected. It was confirmed that the laryngeal cancer reduced undetectably or almost disappeared.

Experiment 2: Woman patient B of fifties diagnosed with a pleural cancer was made to keep on using the present embodiment for 2 hours (by repeating the 30 minutes' use with a 10 minutes' break) almost everyday, for about 4 months from September through December in 2001. When an X-ray test was performed in a hospital after the 4 months' use of the present embodiment, it was confirmed that the pleural cancer reduced noticeably.

Experiment 3: Nineteen-year-old woman C suffering from atopic dermatitis was made to keep on using the present embodiment for 2 to 3 hours (by repeating the 30 minutes use with 10 minutes break) almost everyday, for about 1 week in January, 2001. Then, the skin irritation on the face turning red was recovered completely.

Experiment 4: Woman patient D of sixties diagnosed with empyema was made to keep on using the present embodiment for 30 minutes to 1 hour (by optionally performing the 30 minutes' use or repeating the 30 minutes' use with a 10 minutes' break), every other day for about 2 months from September and October in 2001. Then, pus was not gathered in the nose, and the patient got to breathe smoothly with her nose.

Experiment 5: Four patients in total (man E of sixties, woman F of fifties, woman G of fifties, and woman H of sixties) suffering from asthma were made to use the present embodiment for about 30 minutes to 1 hour (by optionally performing the 30 minutes' use or repeating the 30 minutes' use with a 10 minutes' break) every other day for about 2 months from January through December in 2001 with the each test period being shifted to each other. The present embodiment has proved to be effective to help patients E, F, G and H to overcome the asthma almost completely.

The embodiment of the present invention has been described hitherto, but the present invention is not limited to the embodiment, and various changes and modifications to the embodiment can be made. For instance, in the present embodiment, the high-temperature steam or the like supply section to supply high-temperature micro particles or vapors to the sauna space are constructed as illustrated in FIG. 5. In other words, the water stored in the water tank 21 is heated by the submerged heater 23 to over 100° C. to turn into vapors, and then discharged to the sauna space. However, in the present invention which is not limited thereto, the water 22 stored in the water tank 21 may be heated by the submerged heater 23 up to about 60 to 70° C., and the water heated to about 60 to 70° C. may be atomized by the ultrasonic vibrator and then discharged to the sauna space by the fan 25.

Furthermore, as described above, the present embodiment is applied to the single room type of sauna space (the type of room in which one user only can use) built in a private house. However, it is possible to apply the present invention to an commercial type of sauna space installed in a motel or to other types of sauna space used by a plurality of people at the same time.

When the present invention is applied to the sauna room used by a plurality of people, the low-temperature mist discharging nozzle for discharging low-temperature mist toward the face (mouth or nose) of each user from a position in vicinity of or over the face or head of each user may be individually installed for each person, or may be wholly installed to be shared by all the users at the same time. At this time, the low-temperature mist discharging nozzle shared altogether by all the users may be constructed with one pipe that laterally extends in front of or over users' faces and with a plurality of holes that are provided in the pipe to supply the low-temperature mist toward the faces of all users.

Further, in the present invention, low-temperature mist discharging nozzles for a small number of people, for example, one person or two or three persons may be provided in a big sauna room where a large number of people, for example, even 10 or more people can be accommodated.

### INDUSTRIAL APPLICABILITY

As described above, according to the present invention, the user seating in the sauna space feels warm to get blood circulation stimulated and get metabolism stimulated by perspiration in the atmosphere of the sauna room full of high-temperature micro particles or vapors of about 40 to 70° C. supplied from the high-temperature steam or the like supply section, while low-temperature mist (micro particles of liquid containing useful-to-human-body substances) of about under 30° C. supplied from the low-temperature mist supplying section are absorbed into the whole body of the user through breathing with mouth, nose and lungs and blood circulation of the user.

At this time, as mentioned above, since the blood circulation and metabolism are stimulated and activated by the high-temperature micro particles or vapors (sauna atmosphere of about 40 to 70° C.) in the body of the user, the useful-to-human-body substances of the low-temperature mist (micro particles) absorbed through lungs respiration are absorbed into blood vessel through mucous membrane of lungs, and are extremely rapidly and effectively absorbed and spread into the whole body of the user by the active circulation of blood of the user.

As described above, the present invention has two separate routes in total, (a) a high-temperature steam or the like supplying route (the high-temperature steam or the like supply section) and (b) the other low-temperature mist supplying route (the low-temperature mist supplying section).

In this case, the high-temperature steam or the like supplying route (a) (the high-temperature steam or the like supply section) is to achieve a steam bath effect that enhances blood circulation or metabolism of the user. Since the high-temperature steam or the like is at high temperature of about 40° C. to 70° C., when the high-temperature steam or the like is supplied toward the face of user, it may get the face of the user burnt or make the user breathe uncomfortably. Therefore, in the present invention, the high-temperature steam or the like is not supplied directly toward the vicinity of the face of the user.

On the other hand, low-temperature mist supplying route (b) (the low-temperature mist supplying section) is to turn the liquid (liquid safe and beneficial to human body even when the liquid is absorbed through lung respiration) of low temperature of about less than 30° C. into low-temperature mist by ultrasonic vibration, which is then discharged toward the face (mouth or nose) of the user from the position over the user and absorbed into the body of the user through lung respiration and blood circulation of the user. When the ultrasonic vibration is applied, the liquid turns into low-temperature mist while the liquid is kept at a level of low temperature. Since the low-temperature mist is supplied at low temperature of about less than 30° C., when the low-temperature mist is supplied toward the face of user, it neither burns the face of the user nor causes the user to have trouble in breathing comfortably.

In the present invention, since the high-temperature steam is supplied from the high-temperature steam or the like supply section and fully stored in the sauna space, the low-temperature mist may fall naturally to the mouth or nose of the user when the low-temperature mist is supplied from the position upper to the user by the low-temperature mist supplying section. Then, the low-temperature mist that has fallen to the mouth or nose of the user is sucked and absorbed into the lungs by lung respiration through the mouth and nose of the user and then absorbed and spread into the whole body of the user through blood circulation.

In the present invention, the above-mentioned ‘two routes’ are used for separately supplying high-temperature steam and low-temperature mist. As a result, the high-temperature steam activates blood circulation while the useful-to-human-body substances contained in the low-temperature mist is more effectively absorbed into the whole body of the user through the blood circulation activated by the high-temperature steam.

In other words, in the present invention, separately from the route (high-temperature supplying section) that supplies high-temperature steam or the like to warm up the sauna room and the body of the user altogether and activate blood circulation of the user, the other route is provided so that the low-temperature mist containing useful-to-human-body substances is supplied to the mouth or nose of the user by the low-temperature mist supplying route (low-temperature mist supplying section), by which the useful-to-human-body substances contained in the low-temperature mist is effectively absorbed into the body of the user through active lung respiration and blood circulation of the user. The characteristics of the present invention as such have never been predicted in the related art.

Particularly, in the present invention, the low-temperature mist may be made of the liquid containing useful-to-human-body substances having various functions of enhancing immunity or promoting natural recovery force or capable of being used for healthful beverages having effects of enhancing natural recovery or improving physical strength for patients or old people suffering from illnesses, such as cancer (particularly, laryngeal cancer, pulmonary cancer, liver cancer and the like), kinds of skin irritations (atopic dermatitis), asthma, empyema or other health problems. The liquid is atomized by the ultrasonic vibrator, and is then absorbed into the body of the user through lung respiration and blood circulation. Therefore, the present invention has proved to be more effective in reinforcing health recovery force for patients and promoting physical strength for general users. In other words, the useful-to-human-body substances of drinks that have generally been taken in the body through the digestion system may be more effectively and rapidly absorbed to the body of the user through lung respiration and blood circulation by turning the substances into the form of micro particles.

As described in the experiments that were conducted by the inventor, the present invention proved more effective for, particularly, the patients suffering from illnesses such as cancer (pulmonary cancer, laryngeal cancer, liver cancer and the like), skin irritations such as atopic dermatitis, asthma, empyema or other health problems, resulting in natural recovery effects and physical strength enhancing effects. It may be because the system of the present invention is considered to result in positive effects as alternative treatment or hyperthermia while it gets the useful-to-human-body substances more effectively absorbed through the lung respiration and blood circulation into the whole body.

Here, the ‘alternative treatment’ is a holistic medical approach that focuses on promotion of the immunity system through restoration of patients' natural recovery force by compensating nutritional defects instead of the common western style treatment method of medication. Recently the alternative treatment has been well and widely accepted by western countries.

The hyperthermia is known as one of alternative treatment methods, a natural treatment method to cure illnesses by warming up human body in a steam sauna or sauna (in hot springs) After the hyperthermia has been reported ‘effective in promoting immunity or metabolism’ by raising the temperature of a human body, it has drawn great attention in western countries like the United States. Particularly, it was reported that some cancer cells had been terminated at high temperature of over 39.3° C., so some cancers are regarded curable naturally by the rise in body temperature.

As described above, in the present invention, (1) high-temperature micro particles or vapors are supplied to the user in a sauna space to raise the body temperature to give effects of alternative treatment or hyperthermia treatment to a variety of illnesses such as cancers, skin irritations including atopic dermatitis, asthma, empyema and rheumatism, and at the same time (2) low-temperature mist containing useful-to-human-body substances having an immunity activating action, an organism conditioning action, or a nourishing/restoring action is supplied to be effectively absorbed into the body of the user through lung respiration and blood circulation and to greatly reinforce curing effects of various illnesses.

Further, in the present invention, as described above, the total two routes, that is, (a) the high-temperature steam or the like supplying route (high-temperature steam or the like supply section) and (b) the low-temperature mist supplying route (low-temperature mist supplying section), are separately constructed, and the high-temperature steam or the like and low-temperature mist respectively supplied by the two routes are supplied simultaneously and continuously for at least over 10 minutes.

Therefore, according to the present invention, the blood circulation in the body of the user is further activated by the high-temperature steam, and the low-temperature mist is supplied continuously for a predetermined period of time (for at least over 10 minutes) simultaneously. Thus, the useful-to-human-body substances contained in the low-temperature mist are more effectively and sufficiently absorbed into the body of the user through lung respiration and the activated blood circulation. It is necessary to supply high-temperature steam and low-temperature mist simultaneously and continuously for at least more than 10 minutes for effective absorption of the useful-to-human-body substances from mouth or nose through lung respiration and blood circulation into the body of the user.

Further, according to the invention, an opening is formed in a portion of the container body which faces the eye of the user, and the opening is covered with transparent doors. Therefore, the user seating in a sauna space of the container body can see outside through the transparent doors that can be opened or closed, thereby improving the comfort of the sauna space because the user can see outside from the inside of the sauna space.

Further, the present invention has transparent doors in which the right and left halves of the opening with respect to the centerline can be opened or closed by the hinged portion. Thus, it is possible for the user to get into a capsule type of a container body from the left or right side.

1. A system for supplying useful-to-human-body substances into a human body utilizing a sauna space, comprising:
a sauna room being used by one or a plurality of users for forming the sauna space almost completely blocked from outside except a ventilation hole performing ventilation with outside while used as a steam bath,
a supporting section provided in the sauna room for supporting the waist and back of a user,
a high-temperature steam or the like supply section for supplying high-temperature micro particles or vapors of about 60° C. or above to the sauna room and raising the temperature of the sauna room to warm up the body of the user in the sauna room and further stimulate blood circulation and metabolism of the user, and
a low-temperature mist supplying section including:
a liquid tank for storing a low-temperature liquid of about 30° C. or below, the low-temperature liquid containing substances having actions useful for the human body, e.g., an immunity activating action against illnesses, a natural healing power enhancing action against illnesses, an organism conditioning action, or a nourishing/restoring action, the low-temperature liquid being able to be used as beverages having effects of curing predetermined illnesses or promoting general physical health, and the low temperature liquid being able to be sucked into the mouth or nose of the user while being turned into mist so that the useful-to-human-body substances are absorbed into the body of the user through lung respiration and blood circulation to achieve the illness curing effect and the physical health promoting effect,
an ultrasonic vibrator for atomizing the liquid stored in the liquid tank, and
a discharging nozzle provided at a position over or near to the face or head of the user for discharging low-temperature mist of 30° C. or below made by atomizing the liquid by the ultrasonic vibrator toward the face of the user,
wherein the low-temperature mist supplying section discharges the low-temperature mist of about 30° C. or below made by the atomization of the liquid from the position over or near to the face or head of the user toward the face of the user for a predetermined period of time simultaneously with the supply of the high-temperature micro particles or vapors from the high-temperature steam or the like supply section,
wherein while the high-temperature micro particles or vapors are discharged from the high-temperature steam or the like supply section to warm up the body of the user and activate blood circulation and metabolism of the user, the low-temperature mist supplied from the low-temperature mist supplying section is sucked through the mouth or nose of the user into the lungs and further absorbed from the lungs to blood vessels, thereby making the useful-to-human-body substances contained in the low-temperature mist absorbed through lung respiration and blood circulation into the body of the user.

2. The system for supplying useful-to-human-body substances into a human body utilizing a sauna space according to claim 1,
wherein the useful-to-human-body substances contained in the liquid are made from at least one material of medicinal herbs such as Korean ginseng, medicinal mushroom and curcuma, rice bran, embryo buds, loquat leaves, loquat seeds, edible mushroom, chitosan and chitin.

3. The system for supplying useful-to-human-body substances into a human body utilizing a sauna space according to claim 1,
wherein the supply of the high-temperature micro particles or vapors of about 60° C. or above from the high-temperature steam or the like supply section to the sauna room and the supply of the low-temperature mist of about 30° C. or below from the low-temperature mist supplying section toward the mouth or nose of the user are performed simultaneously and continuously for at least 10 minutes.

4. The system for supplying useful-to-human-body substances into a human body utilizing a sauna space according to claim 1,
wherein the sauna room is formed substantially in the shape of a capsule, as seen from above, an opening is formed in an upper portion of the sauna room for allowing entrance or exit of an user, the opening is provided with transparent doors in the shape of lids which are mounted to open or close the opening, and the opening is positioned to face the user when the body of the user is supported by the supporting section.

5. The system for supplying useful-to-human-body substances into a human body utilizing a sauna space according to claim 4,
wherein the opening of the sauna room is provided with a hinged portion extending along a longitudinal centerline that divides the opening into symmetrical right and left halves as seen from a user supported by the supporting section, and the transparent doors are composed of a first transparent door mounted to the hinged portion for opening or closing a right portion of the opening from the centerline as seen from the user side, and a second transparent door mounted to the hinged portion for opening or closing a left portion of the opening from the centerline as seen from the user side.

6. The system for supplying useful-to-human-body substances into a human body utilizing a sauna space according to claim 1,
wherein a bottom of the sauna room is provided with a tank for temporarily collecting and storing moisture resulting from dropping of the high-temperature micro particles or vapors of 60° C. or above from the high-temperature steam discharging section before the moisture is drained out of the sauna room.
